(19) United States
(12) Patent Application Publication
(10) Pub. No.: US 2003/0140945 A1
(43) Pub. Date: Jul. 31, 2003

(54) Substrate processing apparatus

(75) Inventor: Yasuhiro Chono, Tosu-shi (JP)

Correspondence Address: David L. Fehrman, Morrison & Foerster LLP, 35th Floor, 555 W. 5th Street, Los Angeles, CA, 90013-1024, US

(73) Assignee: TOKYO ELECTRON LIMITED, Tokyo (JP)

(21) Appl. No.: 10/352,408

(22) Filed: Jan. 28, 2003

(30) Foreign Application Priority Data
Jan. 30, 2002 (JP) 2002-021534

(51) Int. Cl. B08B 5/00

(52) U.S. Cl. 134/11; 134/22.1; 134/30; 134/31; 134/95.2; 134/166 R

(57) ABSTRACT

A substrate processing apparatus and a substrate processing method are provided wherein particles etc. adhering to a substrate after processing can be reduced.

According to a substrate processing apparatus 23a in which processing is performed to a substrate placed inside a chamber 45 by supplying ozone gas and steam to the substrate, said chamber 45 is cleaned by supplying ozone water into said chamber 45. Moreover, according to a substrate processing method for processing a substrate W by supplying ozone gas to the substrate W, a substrate W is placed inside the chamber 45, and the substrate W is processed by supplying ozone gas and steam to said substrate W, and then the substrate W is unloaded from said chamber 45, and after that, said chamber 45 is cleaned by supplying ozone water into said chamber 45.

### CROSS REFERENCE TO RELATED APPLICATIONS

The subject application is related to subject matter disclosed in Japanese Patent Application No. 2002-21534 filed on Jan. 30, 2002 to which the subject application claims priority under Paris Convention and which are incorporated herein by reference.

### BACKGROUND OF THE INVENTION

1. Field of the Invention

The present invention relates to a substrate processing apparatus and a substrate processing method wherein substrates such as a semiconductor wafer and a glass substrate for LCD, etc. are processed by a mixed fluid of ozone gas and steam.

2. Related Background Art

For example in a manufacturing process of a semiconductor device, a processing system is employed for removing contaminants adhered to a semiconductor wafer (hereinafter referred to as a “wafer”) and separating a resist applied on a wafer. As in a known resist separation process, a resist is reformed to be water-soluble, and then the reformed resist is separated from a wafer by pure water. The processing system for separating a resist in this way is equipped with a substrate processing apparatus that provides ozone gas and steam into a chamber, in which a wafer is contained, to oxidize and reform the resist to be water-soluble.

However, the conventional substrate processing apparatus has a disadvantage that contaminants, particles and reformed resists, etc. separated from a wafer may adhere to the interior of the chamber after processing and thus contaminate subsequent wafer to be processed by adhering thereto.

### SUMMERY OF THE INVENTION

Accordingly, it is an object of the present invention to provide a substrate processing apparatus and a substrate processing method, wherein particles etc. adhering to a substrate after processing can be reduced.

To solve the above problem, a substrate processing apparatus in which a substrate placed in a chamber is processed by supplying ozone gas and steam, and characterized by cleaning said chamber by supplying ozone water into said chamber is provided according to the present invention.

The chamber comprises: a chamber supply channel to supply a processing fluid including ozone gas, and ozone water; a chamber discharge channel to discharge fluids; and a change-over mixing valve inserted between a channel for supplying said processing fluid or ozone water, and said chamber supply channel, said change-over mixing valve supplying said processing fluid into said chamber when resist water-solubilizing processing is performed and supplying said ozone water into said chamber when chamber cleaning is performed, by changing over the fluids.

Openings of said chamber supply channel and said chamber discharge channel are preferably formed on the surface of the inside wall of said chamber opposing against each other, and preferably the opening of said chamber supply channel is located above a substrate and the opening of said chamber discharge channel is located below the substrate.

Since the chamber of the substrate processing apparatus is cleaned by supplying ozone water, contamination by adhesion of foreign matters inside the chamber to a substrate can prevented, according to the present invention.

A channel for supplying a dry gas can be connected to said chamber supply channel through said change-over mixing valve, and when chamber drying is performed, said change-over mixing valve can be utilized to change over and supply said dry gas into said chamber. Moreover, said chamber further comprises a heater that can be utilized to raise the temperature inside said chamber when chamber drying is performed.

According to the present invention, a resist water-solubilizing processing and chamber drying can be performed in the substrate processing unit.

The chamber may comprises: a chamber supply channel to supply ozone gas, pure water, steam or ozone water; a chamber discharge channel to discharge fluids; and a change-over mixing valve inserted between a channel for supplying ozone gas, pure water or stem, and said chamber supply channel, and said change-over mixing valve can be utilized to change over or mix fluids to produce ozone water by mixing the ozone gas and pure water or steam inside the body of said change-over mixing valve, inside said chamber supply channel or inside said chamber. Moreover, the processing apparatus can further comprises a mist trap for separating steam from a mixed fluid of ozone gas and steam collected from said chamber.

Moreover, by comprising an ozone water producing apparatus for producing ozone water by passing ozone gas collected from said chamber through pure water, the processing apparatus characterized by producing ozone water for cleaning said chamber by said ozone water producing apparatus is provided. In this instance, ozone gas used for substrate processing can be reused for chamber cleaning.

Preferably, the substrate processing apparatus further comprises an ozonolysis apparatus for decomposing ozone gas collected from said chamber or said ozone water producing apparatus.

Said chamber can be formed to comprise: a chamber supply channel to supply a processing fluid including ozone gas, and ozone water; and a chamber discharge channel to discharge fluid, and a mist trap which is connected to said chamber discharge channel to separate fluid collected from said chamber into liquid and gas, and between said ozone water producing apparatus and said mist trap, a recycling ozone gas supply channel is provided to direct ozone gas separated by said mist trap to said ozone water producing apparatus.

Said chamber can be formed to comprise: a chamber supply channel to supply a processing fluid including ozone gas, and ozone water; and a chamber discharge channel to discharge fluid, and a mist trap which is connected to said chamber discharge channel to separate fluid collected from said chamber into liquid and gas, and a fluid channel is provided to direct ozone gas separated by said mist trap to said ozone water producing apparatus and said ozonolysis apparatus, said fluid channel for directing ozone gas to said ozone water producing apparatus comprises a flow rate control valve. According to the present invention, the concentration of ozone water and the amount of ozone gas flowing into the ozone water producing apparatus can be controlled by the flow rate control valve.

Said chamber can be formed to comprise: a chamber supply channel to supply a processing fluid including ozone gas, and ozone water; and a chamber discharge channel to discharge fluids, and a mist trap which is connected to said chamber discharge channel to separate fluid collected from said chamber into liquid and gas, and between said ozone water producing apparatus and said mist trap, a recycling ozone gas supply channel is provided to direct ozone gas separated by said mist trap to said ozone water producing apparatus, the downstream end of said recycling ozone gas supply channel being immersed in pure water or ozone water retained in said ozone water producing apparatus.

Preferably, said ozone water producing apparatus comprises: an ozone gas exhaust pipe to discharge ozone gas from the upper part of said ozone water producing apparatus; an ozone water producing apparatus drain pipe to drain ozone water or pure water from the lower part of said ozone water producing apparatus; and an ozone water supply channel to supply produced ozone water into said chamber. The substrate processing apparatus can further comprises: an ozone gas generator; and a pipe to direct ozone gas produced by said ozone gas generator to said ozone water producing apparatus, the downstream end of said ozone gas pipe being immersed in ozone water or pure water retained in said ozone water producing apparatus.

Moreover, according to the present invention, a substrate processing method is provided wherein a substrate is processed by supplying a processing fluid including ozone gas to the substrate, the method being characterized by comprising: placing said substrate into a chamber; processing said substrate by supplying said processing fluid to said substrate; unloading said substrate from said chamber; and then cleaning said chamber by supplying ozone water into said chamber. Furthermore, the substrate processing method is provided characterized further by producing ozone water for cleaning said chamber by passing ozone gas collected from said chamber through pure water.

Chamber drying can be performed by supplying a dry gas to said chamber after cleaning of said chamber. Chamber drying can also be performed by raising the temperature inside said chamber after cleaning of said chamber.

Furthermore, according to the present invention, a substrate processing method is provided wherein a substrate is processed by supplying a processing fluid including ozone gas to the substrate, the method being characterized by comprising: placing said substrate into a chamber; processing said substrate by supplying said processing fluid to said substrate; unloading said substrate from said chamber; and then cleaning said chamber by supplying ozone water produced by supplying a mixed fluid of ozone gas and steam to said chamber to be condensed in said chamber, or by mixing ozone gas and steam or pure water before flowing into the chamber.

The temperature can be controlled to hasten condensation of said ozone gas and steam or producing of ozone water.

### BRIEF DESCRIPTION OF THE DRAWINGS

FIG. 1 is a plane view of a processing system.

FIG. 2 is a side view of the processing system.

FIG. 3 is a diagonal view of a substrate processing unit according to embodiments of the present invention.

FIG. 4 is a longitudinal sectional view of the substrate processing unit according to the embodiments of the present invention.

FIG. 5 is a explanatory drawing explaining the circuitry of the substrate processing unit according to the embodiments of the present invention.

### DESCRIPTION OF THE PREFERRED EMBODIMENTS

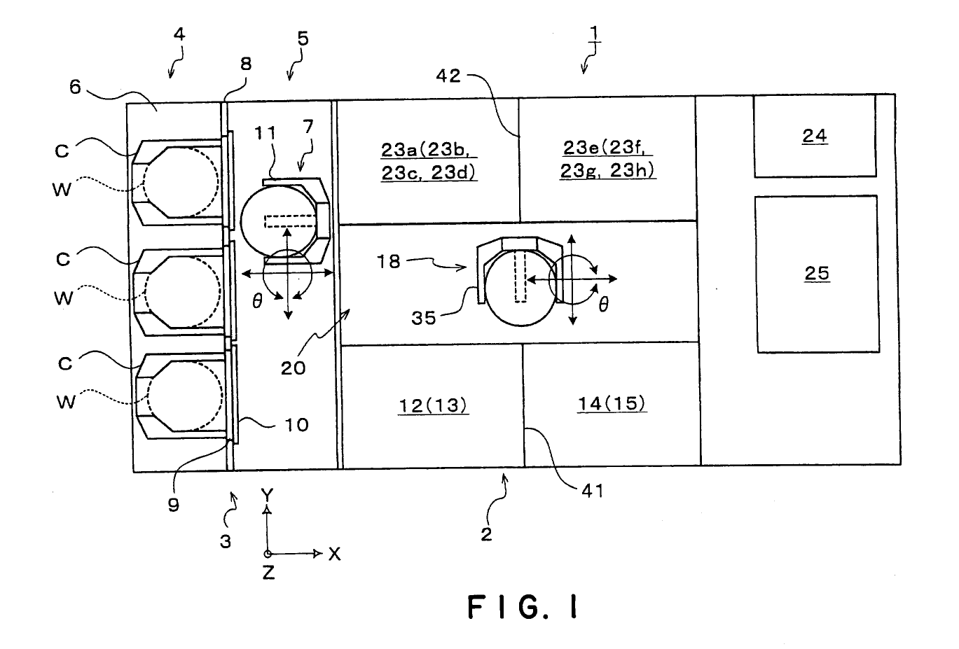

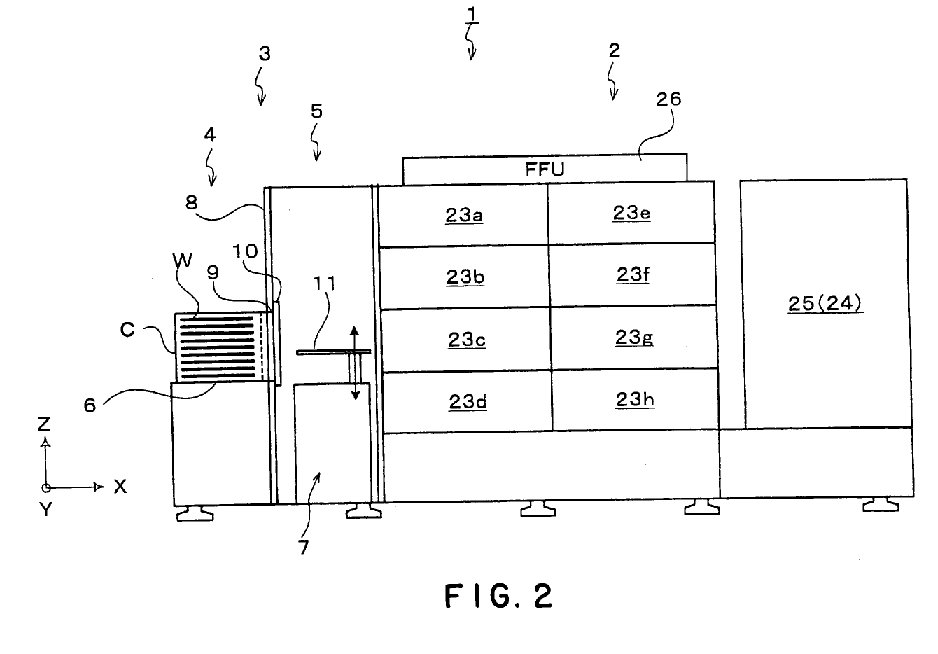

Hereinafter, preferred embodiments of the present invention will be explained with respect to a substrate processing unit performing as a substrate processing apparatus which water-solubilizes a resist applied on a wafer, as an example of a substrate. FIG. 1 is a plane view of a processing system 1 incorporating substrate processing units 23a to 23h according to the present embodiment. FIG. 2 is a side view of the processing system 1. The processing system 1 is composed of a processing section 2 for processing a wafer W by cleaning and water-solubilizing a resist and loading/unloading section 3 for loading and unloading the processing section 2 with a wafer W.

The loading/unloading section 3 is composed of an in/out port 4 wherein a mount stand 6 is installed for mounting a container (carrier C) which can accommodate a plurality of sheets, for example 25 sheets, of wafers W in a substantially horizontal position at regular intervals and a wafer-carrying module 5 comprising a wafer-carrying apparatus 7 for transfer of a wafer W between the carrier C mounted on the mount stand 6 and the processing section 2.

A wafer W can be loaded and unloaded through one of the side surfaces of the carrier C, and an openable/closable cover member is installed on the side surface of the carrier C. A shelf board is also installed on the inner wall of the carrier C, with 25 of slots formed thereon to accommodate wafers W, to keep wafers W at regular intervals. Wafers W are accommodated respectively in each slot with its front-side surface (defined as a surface on which a semiconductor device is formed) up (defined as an upper direction when a wafer W is horizontally held).

On the mount stand 6 of the in/out port 4, three carriers, for example, can be mounted side by side at predetermined points in a horizontal position in Y direction. The carrier C is mounted for its side surface with the cover member to face a separating wall 8 between the in/out port 4 and the wafer-carrying module 5. Corresponding to the mounting location of the carrier C, a window portion 9 is formed on the separating wall 8, and a window open/close mechanism 10 is installed to open and close the window portion 8 with a shutter etc. on the side of the wafer-carrying module 5 of the window portion 9.

The window open/close mechanism 10 can open and close the cover member installed on the carrier C as well, and can concurrently open and close the window portion 9 and the cover member of the carrier C. A wafer W can be carried by the wafer-carrying apparatus 7 disposed in the wafer-carrying module 5 having an access to the carrier C when a wafer-loading/unloading entrance/exit of the carrier C can be communicated with the wafer-carrying module 5 upon opening the window portion 9.

The wafer-carrying apparatus 7 disposed in the wafer-carrying module 5 is configured to be movable in both Y direction and Z direction and also rotatable within X-Y plane (in θ direction). Moreover, the wafer-carrying apparatus 7 has an unloading arm 11 for holding a wafer W, and this unloading arm 11 is slidable in X direction. In this way, the wafer-carrying apparatus 7 can access any slots, whatever the height the slot is formed at, in all the carriers C mounted on the mount stand 6 and also can carry a wafer W from the side of the in/out port 4 to the side of the processing section 2, and conversely from the side of the processing section 2 to the side of the in/out port 4 by accessing a primary wafer-carrying apparatus 18 disposed in the processing section 2.

The processing section2 comprises a wafer-carrying part 20 comprising the primary wafer-carrying apparatus 18, four substrate cleaning units 12, 13, 14, 15 and substrate processing units 23a-23h of the present embodiment. Moreover, the processing section 2 comprises an ozone gas generator 24 for producing ozone gas provided to the substrate processing units 23a-23h and a chemical liquid retaining unit 25 for retaining specific processing liquid to feed the substrate cleaning units 12, 13, 14, 15. At the ceiling of the processing section 2, a fan filter unit (FFU) 26 is disposed for the downflow of clean air to each unit and the primary wafer-carrying apparatus 18.

The structure allows that a part of the downflow from the fan filter unit (FFU) 26 flows out toward the wafer-carrying module 5. In this way, cleanliness of the processing section 2 is maintained by preventing any particles etc. from entering the processing section 2 from the wafer-carrying module 5.

The primary wafer-carrying apparatus 18 disposed at the wafer-carrying section 20 is configured to be movable in both X direction and Y direction and also rotatable within X-Y plane (in θ direction). Moreover, the primary wafer-carrying apparatus 18 has a carriage arm 35 for holding a wafer W, and the carriage arm 35 is slidable in Y direction. In this way, the primary wafer-carrying apparatus 18 is disposed to be accessible from the wafer-carrying apparatus 7 disposed in the wafer-carrying module 5, the substrate cleaning units 12, 13, 14, 15 and all the units from the substrate processing units 23a-23h.

Each of the substrate cleaning units 12, 13, 14, 15 processes a wafer W by cleaning and drying before the wafer W is loaded into the substrate processing unit 23a-23h, and also processes a wafer W by cleaning and drying after the resist of the wafer W is water-solubilized at the substrate processing unit 23a-23h. The substrate cleaning units 12, 13, 14, 15 are disposed two-tiered in a vertical direction, two units at a tier. As shown in FIG. 1, although the substrate cleaning units 12 and 13 and the substrate cleaning units 14 and 15 are structured symmetrically with respect to a wall 41 which is abound therebetween, each of the substrate cleaning units 12, 13, 14, 15 basically comprises the same configuration apart from the symmetry.

Each of the substrate processing units 23a-23h water-solubilizes a resist applied on a front surface of a wafer W. As shown in FIG. 2, the substrate processing units 23a-23h are disposed four-tiered in a vertical direction, two units at a tier. On the left tiers, the substrate processing units 23a, 23b, 23c, 23d are disposed in this order from the top, and on the right tiers, the substrate processing units 23e, 23f, 23g, 23h are disposed in this order from the top. As shown in FIG. 1, although the substrate processing units 23a and 23e, the substrate processing units 23b and 23f, the substrate processing units 23c and 23g and the substrate processing units 23d and 23h are structured symmetrically with respect to a wall 42 which is a bound of each of the pairs, each of the substrate processing units 23a-23h basically comprises the same configuration apart from the symmetry. In this connection, the structure of the substrate processing units 23a will hereinafter be explained in detail by way of example.

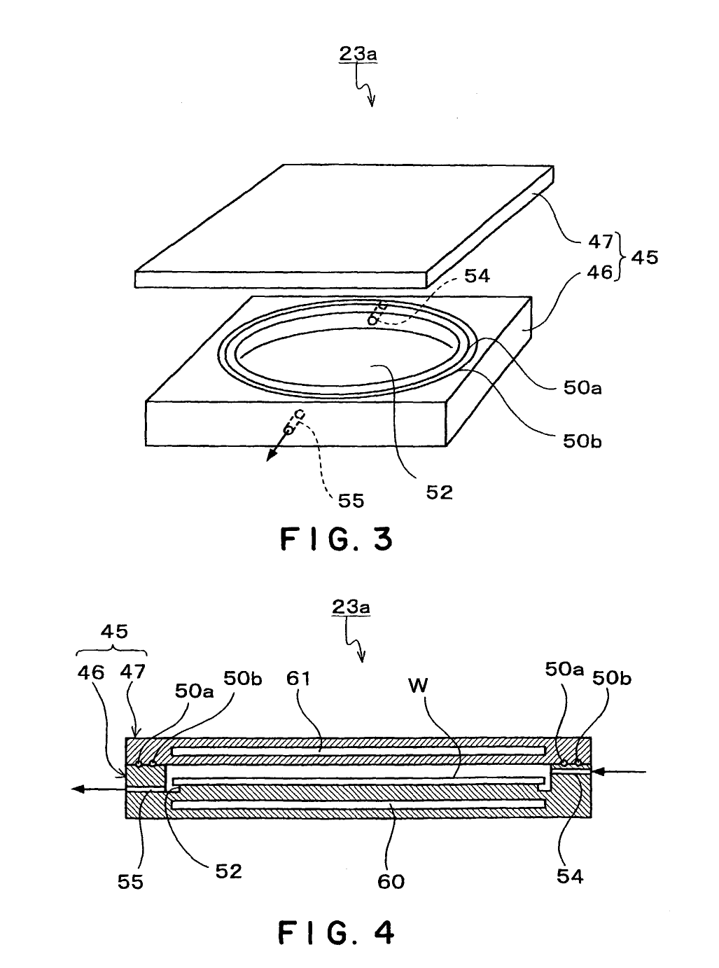

FIG. 3 is a diagrammatic view of the substrate processing units 23a. An airtight-structured chamber 45 provided at the substrate processing units 23a consists of a substrate container 46 with its upper part open and a cover 47 for covering the substrate container 46 on the upper part. Sealing members 50a, 50b are provided between the upper surface of the substrate container 46 and the lower surface of the cover 47 to prevent an atmosphere inside the chamber 45 from flowing out when the lower surface of the cover 47 makes contact with the substrate container 46. Thus, the atmosphere inside the chamber 45 can be sealed. On the upper surface of the substrate container 46, the sealing member 50a is provided around the internal space of the chamber 45 to completely seal an atmosphere inside the chamber 45. The sealing member 50b is provided outside the sealing member 50a. Additionally, for the use of the sealing members 50a, 50b, an O-ring can be applied for example, and in this case, grooves shall be provided on the upper surface of the substrate container 46 and on the lower surface of the cover 47 for the O-ring to be wedged therebetween.

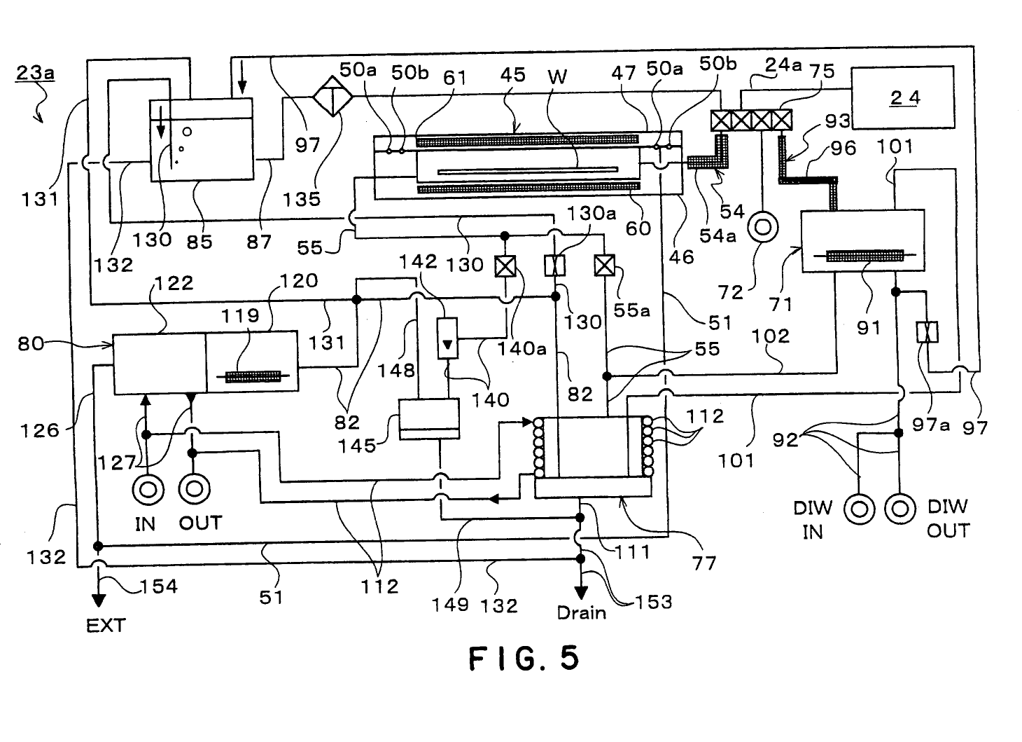

Moreover, as shown in FIG. 5, a sealing member exhaust circuit 51 is provided for exhausting an atmosphere between the sealing member 50a and the sealing member 50b. An adequate suction means, not shown, is provided at the sealing member exhaust circuit 51 so that the atmosphere between the sealing member 50a and the sealing member 50b in the gap between the upper surface of the substrate container 46 and the lower surface of the cover 47 can be discharged and depressurized. Consequently, the atmosphere inside the chamber 45 can be sealed by the upper surface of the substrate container 46 and the lower surface of the cover 47 being tight on each other.

For mounting a wafer W, a substrate mount stand 52 is provided inside the substrate container 46. As shown in FIG. 4, when a wafer W is placed in the chamber 45, the wafer W is mounted with the lower surface (backside surface) in contact with the upper surface of the substrate mount stand 52. Moreover, a chamber supply channel 54 for supplying processing fluid etc. to the internal space of the chamber 45 and a chamber discharge channel 55 for discharging fluid inside the chamber 45 are provided by piercing through the side wall of the substrate container 46. The chamber supply channel 54 is provided for the processing fluid to spout to a wafer W from above the upper surface (front surface) of the wafer W mounted on the substrate mount stand 52. The chamber discharge channel 55 is provided for the fluid to be discharged from below the lower surface of a wafer W mounted on the substrate mount stand 52. Moreover, a discharge opening of the chamber supply channel 54 and a spout opening of the chamber discharge channel 55 are disposed in place to be diametrically opposed against each other on the circumference of a wafer W, in other words to have a center angle of 180 degrees on the circumference of a wafer W.

When a wafer W is placed in the chamber 45 and the cover 47 is closed, the lower surface of the cover 47 covers the upper surface of the wafer W at a very close position to the wafer W, and a processing fluid is supplied into the gap formed between the upper surface of the wafer W and the lower surface of the cover 47, and thus the upper surface of the wafer W can be processed. Moreover, the wafer W is disposed to have a margin between the inner wall of the substrate container 46 and the rim of the wafer W, and the processing fluid is supplied into the gap between the inner wall of the substrate container 46 and the rim of the wafer W, and thus the rim of the wafer W can be processed. Furthermore, since the contact surface area of the upper surface of the substrate mount stand 52 and the lower surface of the wafer W is smaller than the area of the lower surface of the wafer W, the peripheral part of the lower surface of the wafer W makes no contact with the upper surface of the substrate mount stand 52. Therefore, the processing fluid is supplied on the peripheral part of the lower surface of the wafer W when the processing fluid is supplied into the chamber 45, and thus the peripheral part of the lower surface of the wafer W can be processed.

Furthermore, alowertemperatureadjuster60 is provided at the bottom of the substrate container 46 and an upper temperature adjuster 61 is provided inside the cover 47. Within the chamber 45, the lower temperature adjuster 60 adjusts the temperature of an atmosphere and the temperature of a wafer W inside the chamber 45 from the bottom and the upper temperature adjuster 61 adjusts the temperature of a fluid and the temperature of a wafer W inside the chamber 45 from above.

FIG. 5 shows a fluid supply circuitry and a fluid discharge circuitry according to the substrate processing unit 23a. The substrate processing unit 23a comprises an ozone gas generator 24, a steam generator 71 which produces steam supplied to a wafer W and a gas source 72 which is a source of supplying gas supplied into the chamber 45. The ozone gas generator 24, the steam generator 71 and the gas source 72 are connected to a chamber supply channel 54 through a change-over mixing valve 75. Additionally, the ozone gas generator 24 can supply ozone gas and oxygen. The gas supplied by the gas source 72 includes purge gas or dry gas, for example inert gas such as N₂ gas or air, etc. Moreover, the chamber supply channel 54 comprises a temperature control 54a which is installed in tubular shape along the shape of the chamber supply channel 54, and the temperature of a fluid, such as ozone gas and steam, passing through the chamber supply channel 54 is adjusted by the temperature control 54a while the fluid passes through the chamber supply channel 54.

Furthermore, the substrate processing unit 23a comprises a mist trap 77 to collect a fluid from the chamber 45 and separate the fluid into liquid and gas, and an ozonolysis apparatus 80 for decomposing ozone gas in the fluid collected from the chamber 45. The chamber discharge channel 55 connects the chamber 45 and the mist trap 77 to deliver a fluid discharged from the chamber 45 to the mist trap 77. Moreover, an open/close valve 55a is inserted in the chamber discharge channel 55, and a processing fluid is discharged from the chamber 45 and prepared for delivery to the mist trap 77 by opening the open/close valve 55a. The mist trap 77 and the ozonolysis apparatus 80 are connected by a mist trap exhaust pipe 82 which exhausts the mist trap 77 of ozone gas. The ozone gas in the chamber 45 is collected by the ozonolysis apparatus 80 by passing through the chamber discharge channel 55, the mist trap 77 and the mist trap exhaust pipe 82.

Water-solubilizing processing of a resist applied on a wafer W is performed by filling the sealed chamber 45 containing the wafer W with a mixed fluid of ozone gas and steam. That is to say, ozone gas supplied by the ozone gas generator 24 and steam supplied by the steam generator 71 are delivered to form a mixed fluid of ozone gas and steam at the change-over mixing valve 75, and then the mixed fluid is supplied into the chamber 45 through the chamber supply channel 54.

Also, when a mixed fluid of ozone gas and steam is discharged from inside the chamber 45, for example, the gas source 72 and the chamber supply channel 54 are connected by switching the change-over mixing valve 75, the gas source 72 is prepared to supply gas into the chamber 45, and a mixed fluid is prepared to be discharged from the chamber discharge channel 55 by opening the open/close valve 55a. Then, the mixed fluid inside the chamber 45 is extruded to the chamber discharge channel 55 by purge gas. The purge gas is supplied at the maximum flow rate of, for example, around 100 liters per minute.

Moreover, ozone gas remaining in the ozone gas generator 24, change-over mixing valve 75 and an ozone gas generator supply channel 24a connecting the ozone gas generator 24 and the change-over mixing valve 75 is discharged by switching the change-over mixing valve 75 for connecting the ozone gas generator supply channel 24a to the chamber supply channel 54 and supply oxygen from the ozone gas generator 24 to eject the ozone gas remaining in the ozone gas generator 24, change-over mixing valve 75 and ozone gas generator supply channel 24a. After that, by switching the change-over mixing valve 75, the gas source 72 and the chamber supply channel 54 are connected, and purge gas is supplied from the gas source 72 into the chamber 45 to eject an atmosphere such as a mixed fluid inside the chamber 45 to the chamber discharge channel 55. In this way, an extra margin of safety is provided by discharging ozone gas from the ozone gas generator 24, the change-over mixing valve 75 and the ozone gas generator supply channel 24a.

Furthermore, the substrate processing unit 23a comprises an ozone water producing apparatus 85 for producing ozone water as a processing liquid to clean inside the chamber 45. The ozone water producing apparatus 85 is connected to the change-over mixing valve 75 through an ozone water supply channel 87 for delivering ozone water into the chamber supply channel 54.

For example, when the chamber 45 is contaminated by adhesion of foreign matters, such as contaminants, particles or reformed resists separated from a wafer, to the inner wall of the chamber 45, the reformed resists etc. are dissolved by ozone water supplied from the ozone water producing apparatus 85 to inside the chamber 45. Furthermore, by opening the open/close valve 55a, ozone water inside the chamber 45 is discharged through the chamber discharge channel 55 so hat the foreign matters is washed out by the ozone water and thus discharged from inside the chamber 45.

The ozone gas generator 24 produces ozone gas by discharging electricity through oxygen. Also, oxygen can be supplied by discontinuing the discharge. The ozone gas and oxygen supplied by the ozone gas generator 24 are supplied to the change-over mixing valve 75 through the ozone gas generator supply channel 24a connecting the ozone gas generator 24 and the change-over mixing valve 75.

The steam generator 71 comprises a heat source 91 inside and produces steam supplied into the chamber 45 by heating pure water (DIW), supplied from a pure water supply circuit 92 to the steam generator 71, to reach a high temperature. The steam produced inside the steam generator 71 is delivered to the change-over mixing valve 75 through a steam supply pipe 93. The steam supply pipe 93 comprises a steam temperature control 96 installed in tubular shape along the shape of the steam supply pipe 93, and steam is temperature-controlled by the steam temperature control 96 while the steam is passing through the steam supply pipe 93. As a result, steam supplied from the steam generator 71 maintains a predetermined temperature while being delivered from the steam generator 71 to the change-over mixing valve 75. Moreover, steam supplied to the change-over mixing valve 75 is mixed with ozone gas at the change-over mixing valve 75 to make a mixed fluid, and the mixed fluid is supplied to chamber 45 bypassing through the chamber supply channel 54. The mixed fluid maintains a predetermined temperature while passing through the chamber supply channel 54 by the temperature control 54a.

A pure water supply channel 97 is inserted conjunctively in the pure water supply circuit 92 and connected to the ozone water producing apparatus 85. A part of pure water supplied from the pure water supply circuit 92 feeds the ozone water producing apparatus 85 through the pure water supply channel 97. A flow rate control valve 97a is inserted in the pure water supply channel 97. The amount of pure water supplied to the ozone water producing apparatus 85 is controlled by the flow rate control valve 97a.

Moreover, the steam generator 71 comprises a steam exhaust pipe 101 connected to the mist trap 77 and a pure water drain pipe 102 connected conjunctively to the chamber discharge channel 55 downstream from the open/close valve 55a. In cases of the situations, such as when steam which is not supplied to a wafer W is to be discharged from the steam generator 71, or when pressure inside the steam generator 71 is to be relieved, the steam exhaust pipe 101 discharges steam into the mist trap 77. When pure water inside the steam generator 71 is to be drained, the pure water is discharged through the pure water drain pipe 102 from the lower part of the steam generator 71 and drained through the chamber discharge channel 55 into the mist trap 77.

The mist trap 77 comprises a mist trap drain pipe 111 for draining liquid therefrom and a cooling water circulation line 112 for cooling fluid therein. Fluid discharged from inside the chamber 45 through the chamber discharge channel 55, steam discharged from the steam generator 71 through the steam exhaust pipe 101, and pure water drained from the steam generator 71 through the pure water drain pipe 102 and the chamber discharge channel 55 are retained inside the mist trap 77. These collected fluids retained inside the mist trap 77 are then cooled down by running a cooling water through the cooling water circulation line 112 wound externally around the mist trap 77. That is to say, the collected fluids retained inside the mist trap 77 including ozone gas, steam, pure water, gas, oxygen, ozone water, etc. can preferably be separated into gas, including ozone gas, and droplets by condensing steam and retaining the condensed steam at the lower portion of the mist trap 77, accordingly. As a result, steam can be separated from the processing fluid discharged from inside the chamber 45. The mist trap 77 is exhausted of gas such as ozone gas inside the mist trap 77 by the mist trap exhaust pipe 82. Moreover, foreign matters, such as reformed resists, particles, contaminants, etc., discharged with ozone water that has cleaned the interior of the chamber 45 can be discharged from the mist trap drain pipe 111 with the liquids inside the mist trap 77.

The ozonolysis apparatus 80 comprises an ozone killer 120 in which ozone gas is decomposed by a heater 119 for heating to reach a high temperature and a cooling apparatus 122 for cooling down the gas after passing through the ozone killer 120. The ozonolysis apparatus 80 also comprises an ozonolysis apparatus exhaust pipe 126 for exhausting ozonolys is apparatus 80 of gas after the ozonolysis and cooling down steps. Ozone gas collected by the ozonolysis apparatus 80 after passing through the mist trap exhaust pipe 82 is then thermally decomposed into oxygen by heating by the heater 119, and cooled down by the cooling apparatus 122. The cooling apparatus 122 comprises a cooling water supply circuit 127 for a cooling water to be circulated and supplied. That is to say, gas inside the cooling apparatus 122 is cooled down by the cooling water being circulated and supplied. In the cooling water supply circuit 127, the cooling water circulation line 112 that cools down the interior of the mist trap 77 is inserted, and thus a part of the cooling water circulating through the cooling water supply circuit 127 is circulated and supplied into the cooling water circulation line 112 to cool down the interior of the mist trap 77. In this way, by removing ozone gas at the ozone killer, the gas discharged by exhausting the processing unit 23a can be detoxified.

In the mist trap exhaust pipe 82, a recycling ozone gas supply channel 130 is inserted conjunctively for supplying ozone gas to the ozone water producing apparatus 85. In the recycling ozone gas supply channel 130, a flow rate control valve 130a is inserted. A part of ozone gas passing through the mist trap exhaust pipe 82 after being discharged from the mist trap 77 is supplied into the ozone water producing apparatus 85 through the recycling ozone gas supply channel 130, and the rest of the ozone gas is delivered to the ozonolysis apparatus 80. The amount of ozone gas supplied to the ozone water producing apparatus 85 is controlled by the flow rate control valve 130a.

Ozone water or pure water is retained inside the ozone water producing apparatus 85 and gas including ozone gas is retained above the retained ozone water or pure water. Moreover, pure water is supplied by the pure water supply channel 97 and ozone gas is supplied by the recycling ozone gas supply channel 130 to the ozone water producing apparatus 85. The pure water supplied by the pure water supply channel 97 is retained inside the ozone water producing apparatus 85. The downstream end of the recycling ozone gas supply channel 130 is immersed in pure water or ozone water retained inside the ozone water producing apparatus 85. That is to say, the configuration allows an ozone water of predetermined concentration to be produced by passing ozone gas supplied from the recycling ozone gas supply channel 130 through pure water or ozone water. That is to say, ozone gas after being supplied into the chamber 45 and to a wafer W and being collected by the mist trap 77 is supplied to the ozone water producing apparatus 85 through the mist trap exhaust pipe 82 and the recycling ozone gas supply channel 130, and passes through pure water to produce ozone water. In this way, ozone gas can be recycled for producing ozone water after being supplied into the chamber 45 and to a wafer W.

Moreover, the ozone water producing apparatus 85 comprises an ozone gas exhaust pipe 131 which discharges ozone gas from the upper space of the ozone water producing apparatus 85 and an ozone water producing apparatus drain pipe 132 which discharges pure water or ozone water from the lower part of the ozone water producing apparatus 85. The downstream end of the ozone gas exhaust pipe 131 is connected in midstream to the mist trap exhaust pipe 82 at the point lower than the connecting point of the upstream end of the recycling ozone gas supply channel 130 and the mist trap exhaust pipe 82. After passing through pure water or ozone water, gas is retained in the upper space inside the ozone water producing apparatus 85. However, in a case that the upper space inside the ozone water producing apparatus 85 is full, the air is discharged from the ozone water producing apparatus 85 through the ozone gas exhaust pipe 131, delivered to the ozonolysis apparatus 80 by the mist trap exhaust pipe 82, and the ozone gas is decomposed. Also, in a case that ozone water which is not supplied to the chamber 45 is to be drained or overflow is to be dewatered from the ozone water producing apparatus 85, the ozone water producing apparatus drain pipe 132 is used for draining. A filter 135 is inserted in the ozone water supply channel 87 so that ozone water produced by recycled ozone gas can be clarified and supplied into the chamber 45.

Between the chamber 45 and the open/close valve 55a, a power exhaust pipe 140 is inserted in the chamber discharge channel 55. In the power exhaust pipe 140, a open/close valve 140a and an ejector 142 is inserted in this order. The power exhaust pipe 140 comprises a power exhaust mist trap exhaust pipe 148 for discharging ozone gas decomposed from the collected fluid which is forcibly discharged, and a power exhaust mist trap drain pipe 149 for draining pure water decomposed from the collected fluid which is forcibly drained. The downstream end of the power exhaust mist trap exhaust pipe 148 is connected in midstream to the mist trap exhaust pipe 82 at the point lower than the connecting point of the upstream end of the recycling ozone gas supply channel 130 and the mist trap exhaust pipe 82.

When fluid is to be forcibly discharged from inside the chamber 45, the open/close valve 140a is opened while the open/close valve 55a is closed. Also, the gas source 72 and the chamber discharge channel 55 are connected by switching the change-over mixing valve 75. Under these conditions, the ejector 142 is actuated, a processing fluid inside the chamber 45 is brought in to the power exhaust pipe 140 through the chamber discharge channel 55, and the fluid can be forcibly discharged to a power exhaust mist trap 145 as a result. The gas is supplied at a flow rate of, for example, around 10 liters per minute. The power exhaust system in this way is employed in a standby state of the chamber 45 before starting processing wafers W, for example, or in a case abnormal situations arise inside the chamber 45.

The mist trap drain pipe 111, the ozone water producing apparatus drain pipe 132 and the power exhaust mist trap drain pipe 149 are connected to a substrate processing unit drain pipe 153 which drains liquids such as pure water from each part of the processing unit 23a. The sealing member exhaust circuit 51 and the ozonolysis apparatus exhaust pipe 126 are connected to a substrate processing unit exhaust pipe 154 which exhausts each part of the processing unit 23a of gas.

The aforementioned explains the configuration of the processing unit 23a, and the other processing units 23b-23h instrumented to the processing system 1 also provides the same configuration as the processing unit 23a wherein a resist applied on a wafer W can be reformed to be water-soluble by a mixed fluid of ozone gas and steam.

Next, processing steps of a wafer W with respect to the processing system 1 in accordance with the configuration of the present embodiment described above will be explained. Firstly, carriers C are mounted on the in/out port 4 by a carrier delivery robot, not shown, each carrier C including, for example, 25 sheets of not-yet cleaned wafers W. Then, the wafers W are unloaded one by one from the carriers C mounted on the in/out port 4 by the unloading arm 11, and the wafers W are transferred from the unloading arm 11 to the primary wafer-carrying apparatus 18. And then, the wafers W are loaded accordingly to each of the substrate cleaning unit 12, 13, 14, 15 by the carriage arm 35, cleaned by removing contaminants such as particles adhered thereto, and dried. After a predetermined cleaning processing is completed in this way, the wafers W are unloaded accordingly from each of the substrate cleaning units 12, 13, 14, 15 by the carriage arm 35. Then, the wafers W that the predetermined cleaning processing is completed are loaded accordingly to each of the substrate processing units 23a-23h by the carriage arm 35 by rotating the primary wafer-carrying apparatus 18 within X-Y plane. And then, a resist applied on the wafer Ware water-solubilized at each of the substrate processing units 23a-23h. The wafers W that the predetermined resist water-solubilizing processing is completed are unloaded accordingly from each of the substrate processing units 23a-23h by the carriage arm 35. After that, the wafers Ware loaded back to each of the substrate cleaning units 12, 13, 14, 15 accordingly by the carriage arm 35 for the cleaning processing of removing the water-solubilized resist adhered to the wafer W. As a result, the resist applied on the wafer W is separated. Each of the substrate cleaning units 12, 13, 14, 15 dries the wafers W after cleaning of the wafers W, and after that, the wafers W are unloaded again from each of the substrate cleaning units 12, 13, 14, 15 by the carriage arm 35. And then, the wafers W are transferred from the carriage arm 35 to the unloading arm 11, and the wafers W without the resists are placed in the carriers C by the unloading arm 11.

Hereinafter processing with the substrate processing unit 23a, as a representative example, will be explained. Firstly, the cover 47 of the substrate processing unit 23a is separated relatively from the upper surface of the substrate container 46. Then, the carriage arm 35 holding a wafer W proceeds into the chamber 45 and mounts the wafer W on the substrate mount stand 52. After that, the carriage arm 35 is withdrawn from inside the chamber 45, and after the withdrawal of the carriage arm 35, the chamber 45 is closed by the cover 47 making contact with the upper surface of the substrate container 46. Then, the chamber 45 is sealed by depressurizing the space between the sealing member 50a and the sealing member 50b by the sealing member exhaust circuit 51.

In the first instance, the temperature of an atmosphere and the temperature of a wafer W inside the chamber 45 are raised by actuating the lower temperature adjuster 60 and the upper temperature adjuster 61 so that uneven resist water-solubilizing processing on the wafer W can be prevented. In the second instance, ozone gas of a predetermined concentration is supplied into the chamber 45. The ozone gas is supplied by connecting the ozone gas generator 24 to the chamber supply channel 54 by switching the change-over mixing valve 75 while the chamber 45 is exhausted by opening the open/close valve 55a of the chamber discharge channel 55. Then, keeping the pressure constant, the interior of the chamber 45 is filled with ozone gas. In this case, the pressure inside the chamber 45 is kept higher than the ambient pressure, for example, gauge pressure of around 0.2 MPa. In this way, the interior of the chamber 45 is filled with ozone gas of a predetermined concentration. Moreover, the temperature of the atmosphere and the temperature of the wafer W inside the chamber 45 are maintained by application of heat from the lower temperature adjuster 60 and the upper temperature adjuster 61. The atmosphere inside the chamber 45 discharged by the chamber discharge channel 55 is discharged to the mist trap 77.

After that, ozone gas and steam are simultaneously supplied into the chamber 45, and a resist water-solubilizing processing on the wafer W is performed. The ozone gas generator 24 and the steam generator 71 is connected to the chamber supply channel 54, and the open/close valve 55a of the chamber discharge channel 55 is opened, and then ozone gas and steam are simultaneously supplied into the chamber 45 which is exhausted concurrently. Steam supplied by the steam generator 71 passes through the steam supply pipe 93 while being temperature-controlled to keep a predetermined temperature, around 115° C. for example, by the steam temperature control 96, and is mixed with ozone gas at the change-over mixing valve 75, and then passes through the chamber supply channel 54. Then, ozone gas inside the chamber 45 is replaced by the mixed processing fluid of ozone gas and steam while the pressure inside the chamber 45 is kept constant. In this case as well, the pressure inside the chamber 45 is kept higher than the ambient pressure, for example, gauge pressure of around 0.2 MPa. Moreover, the temperature of the atmosphere and the temperature of the wafer W inside the chamber 45 are maintained by application of heat from the lower temperature adjuster 60 and the upper temperature adjuster 61. In this way, a resist applied on the wafer W is oxidized by the mixed processing fluid of ozone gas and steam filled inside the chamber 45.

During the resist water-solubilizing processing, the mixed processing fluid is continuously supplied from the chamber supply channel 54 and discharged from the chamber discharge channel 55. The chamber supply channel 54 spouts out the mixed processing fluid from above the upper surface of the wafer W. The chamber discharge channel 55 discharges the mixed processing fluid from the opposed position against the chamber supply channel 54 on the circumference of the wafer W and from below the lower surface of the wafer W. Accordingly, the mixed processing fluid on the upper surface of the wafer W flows toward the chamber discharge channel 55 through the gap formed between the upper surface of the wafer W and the lower surface of the cover 47. Moreover, the mixed processing fluid around the circumference of the wafer W flows toward the chamber discharge channel 55 along the rim of the wafer W. A resist water-solubilizing processing on the wafer can also be performed by the mixed processing fluid filled inside the chamber 45 in consequence of stopping supply of the mixed processing fluid from the chamber supply channel 54 and keeping the pressure inside the chamber 45 constant.

After a predetermined resist water-solubilizing processing is completed, the mixed processing fluid of ozone gas and steam is discharged from the chamber 45. Firstly, the gas source 72 is connected to the chamber supply channel 54 by switching the change-over mixing valve 75, and the open/close valve 55a of the chamber discharge channel 55 is opened. Then, a purge gas is supplied from the source of gas 72 into the chamber 45 which is exhausted concurrently. As a result, the mixed processing fluid of ozone gas and steam inside the chamber supply channel 54, chamber 45 and the chamber discharge channel 55 is discharged, and the gas can purge inside the chamber supply channel 54, chamber 45 and chamber discharge channel 55. The discharged ozone gas is discharged to the mist trap 77 through the chamber discharge channel 55.

lower temperature adjuster 60 upper temperature adjuster 61

After the resist water-solubilizing processing is completed, the wafer W is unloaded from inside the processing unit 23a. The cover 47 of the substrate processing unit 23a is separated relatively from the upper surface of the substrate container 46. Then, the carriage arm 35 is proceeded into the apparatus by the primary wafer-carrying apparatus 18, receives the wafer W by separating the same from the substrate mount stand 52, and withdraws from inside the chamber 45.

Incidentally, the collected fluids, collected from the chamber 45 to the mist trap 77 through the chamber discharge channel 55, such as ozone gas, steam, pure water, gas and oxygen, are retained in the mist trap 77 and separated into gas including ozone gas and liquid. The gas is discharged from the mist trap 77 through the mist trap exhaust pipe 82, and a part of the gas including ozone gas is supplied into the ozone water producing apparatus 85 through the recycling ozone gas supply channel 130, and the rest of the gas is delivered to the ozonolysis apparatus 80. Ozone gas supplied into the ozone water producing apparatus 85 becomes bubbles passing through pure water or ozone water to produces an ozone water of a predetermined concentration. Meanwhile, inactive gas such as N₂ gas, gas such as air, oxygen, etc. passing directly through pure water are discharged from the ozone water producing apparatus 85 by the ozone gas exhaust pipe 131, and delivered to the ozonolysis apparatus 80 afterward. Regarding the gas in the ozonolysis apparatus 80 collected from the chamber 45 and the ozone water producing apparatus 85, ozone gas included in the gas is thermally decomposed into oxygen, cooled down and discharged through the ozonolysis apparatus exhaust pipe 126.

After completion of a certain number of times of the whole substrate processing cycle using the substrate processing unit 23a, a chamber cleaning process is employed for cleaning the chamber 45 because, regarding the above described substrate processing steps using the substrate processing unit 23a, the foreign matters, such as reformed resists, particles and contaminants, separated from wafers W are adhered to the interior of the chamber 45 and the adhered foreign matters increase corresponding to the number of the wafers W processed with the substrate processing unit 23a.

The chamber 45 is sealed after the processed wafer W is unloaded from the substrate processing unit 23a. Then, the ozone water supply channel 87 is connected to the chamber supply channel 54 by switching the change-over mixing valve 75, and the open/close valve 55a of the chamber discharge channel 55 is opened, and then ozone water is supplied into the chamber 45 which is exhausted concurrently. While the chamber 45 is cleaned, the chamber supply channel 54 keeps supplying ozone water and the chamber discharge channel 55 keeps discharging ozone water. Ozone water flows toward the chamber discharge channel 55 through the gap formed between the upper surface of the substrate mount stand 52 and the lower surface of the cover 47. Moreover, ozone water flows toward the chamber discharge channel 55 along the inside wall of the substrate container 46 and the circumference of the substrate mount stand 52. In this way, the interior of the chamber 45 is cleaned discharging foreign matters from the chamber 45 with ozone water. The foreign matters and ozone water are discharged to the mist trap 77 through the chamber discharge channel 55. In this way, even if contaminants, particles, reformed resists, etc. separated from wafers W are adhered inside the chamber 45 after processing, cleaning of the interior of the chamber 45 by supplying ozone water prevents subsequent wafers W to be processed from being contaminated by the foreign matters. Moreover, ozone gas consumption is restrained since ozone gas used for processing of wafers W can be reused for cleaning the chamber 45.

In addition, chamber drying can be performed after cleaning of the chamber 45. The chamber drying methods include a method for supplying a dry gas into the chamber 45, a method for raising the temperature inside the chamber by a heater and a combination of these methods.

For example, the method for supplying a dry gas into the chamber 45 comprises: connecting the gas source 72 to the chamber supply channel 54 by switching the change-over mixing valve 75, opening the open/close valve 55a of the chamber discharge channel 55 and supplying a dry gas from the gas source 72 into the chamber 45 which is exhausted concurrently. For the dry gas, the same kind or a deferent kind of the purge gas can be utilized. Moreover, the temperature of the gas can be raised and used in order to hasten the process of chamber drying.

The method for raising the temperature inside the chamber comprises, for example: raising the temperature inside the chamber 45 to a predetermined temperature by the lower temperature adjuster 60 and the upper temperature adjuster 61, and maintaining said predetermined temperature inside the chamber 45 for a predetermined time period.

An example of the preferred embodiments of the present invention is described above, however, the present invention is not limited to the precise forms described above. For example, substrates may not be limited to the semiconductor wafers, but expanded to include other substrates such as glass substrates for LCD, CD substrates, printed-wiring boards, ceramic substrates, etc.

The processing liquid for cleaning the chamber 45 can be produced by condensing a mixed fluid of ozone gas and steam into droplets of ozone water. In this instance, firstly, after a wafer W is unloaded from inside the substrate processing unit 23a and the chamber 45 is sealed, ozone gas and steam are supplied into the chamber 45. That is to say, the ozone gas generator 24 and the steam generator 71 are connected to the chamber supply channel 54 by switching the change-over mixing valve 75, and ozone gas and steam are delivered from the ozone gas generator 24 and the steam generator 71 respectively. Then, the mixed fluid of ozone gas and steam is supplied into the chamber 45. After filling the chamber 45 with a predetermined amount of the mixed fluid, the attemperation by the lower temperature adjuster 60 and the upper temperature adjuster 61 is stopped to produce droplets of ozone water inside the chamber 45 due to condensation of the mixed fluid in the chamber 45 with the temperature inside the chamber 45 lowered. The interior of the chamber 45 can be cleaned also with the ozone water thus produced by droplets. Meanwhile, by stopping attemperation by the lower temperature adjuster 60 and the upper temperature adjuster 61 in advance before starting supplying the mixed fluid of ozone gas and steam, the temperature inside the chamber 45 can be lowered to the degree for the mixed fluid to be condensed. Moreover, the lower temperature adjuster 60 and the upper temperature adjuster 61 can be configured to function as a cooler which cools down the temperature inside the chamber 45 so that the mixed fluid is condensed faster inside the chamber 45 with its temperature rapidly cooled down. Furthermore, the temperature of the mixed fluid of ozone gas and steam passing inside the chamber supply channel 54 can be lowered by the temperature control 54a for the mixed fluid to be condensed inside the chamber supply channel 54, and ozone water produced in advance by condensation in this way can be supplied into the chamber 45.

Moreover, instead of producing ozone water by the ozone water producing apparatus 85, ozone water can be produced inside the body of the change-over mixing valve 75, inside the chamber supply channel 54 or inside the chamber 45. For example, by simultaneously supplying ozone gas from the ozone gas generator 24 and steam or pure water from the steam generator 71, ozone water can be produced at the change-over mixing valve 75 by mixture of ozone gas and steam or pure water to be supplied into the chamber 45 for cleaning.

Ozone water can be produced also by supplying ozone gas from the ozone gas generator 24 to the ozone water producing apparatus 85. For example, a pipe (not shown) is provided for directing ozone gas from the ozone gas generator 24 to the ozone water producing apparatus 85, the downstream end of the ozone gas pipe being immersed in ozone water or pure water retained in said ozone water producing apparatus. As a result, ozone gas passes through pure water and ozone water retained at the bottom of the ozone water producing apparatus 85, and thus ozone water can be produced. In this instance, the space can be saved. Moreover, pure water can be supplied to the change-over mixing valve 75 or into the chamber 45 directly from the pure water supply circuit 92.

According to the substrate processing apparatus and the substrate processing method of the present invention, the chamber of the substrate processing apparatus is cleaned by supplying ozone water to prevent a substrate being contaminated by adhesion of foreign matters inside the chamber. Moreover, ozone gas consumption is reduced since ozone gas used for substrate processing can be reused for cleaning the chamber.

What is claimed is:

1. A substrate processing apparatus wherein a substrate placed inside a chamber is processed by supplying ozone gas and steam to the substrate, and characterized by supplying ozone water into said chamber to clean said chamber.

2. A substrate processing apparatus according to claim 1, characterized in that said chamber comprises:
a chamber supply channel to supply a processing fluid including ozone gas, and ozone water;
a chamber discharge channel to discharge fluids; and
a change-over mixing valve inserted between a channel for supplying said processing fluid or ozone water, and said chamber supply channel,
said change-over mixing valve supplying said processing fluid into said chamber when resist water-solubilizing processing is performed and supplying said ozone water into said chamber when chamber cleaning is performed, by changing over the fluids.

3. A substrate processing apparatus according to claim 2, characterized in that said chamber supply channel and said chamber discharge channel have openings on the surface of the inside wall of said chamber opposing against each other,
said opening of the chamber supply channel being located above a substrate,
said opening of the chamber discharge channel being located below a substrate.

4. A substrate processing apparatus according to claim 2, characterized in that a channel for supplying a dry gas is connected to said chamber supply channel through said change-over mixing valve,
said change-over mixing valve changing over and supplying said dry gas into said chamber when chamber drying is performed.

5. A substrate processing apparatus according to claim 2, characterized in that said chamber further comprises a heater, said heater raising the temperature inside said chamber when chamber drying is performed.

6. A substrate processing apparatus according to claim 1, characterized in that said chamber comprises:
a chamber supply channel to supply ozone gas, pure water, steam or ozone water;
a chamber discharge channel to discharge fluids; and
a change-over mixing valve inserted between a channel for supplying ozone gas, pure water or steam, and said chamber supply channel,
said change-over mixing valve changes over or mixes fluids to produce ozone water by mixing ozone gas and pure water or steam inside the body of said change-over mixing valve, inside said chamber supply channel or inside said chamber.

7. A substrate processing apparatus according to claim 1, characterized by comprising a mist trap to separate steam from a mixed fluid of ozone gas and steam collected from said chamber.

8. A substrate processing apparatus according to claim 1, characterized by comprising an ozone water producing apparatus to produce ozone water by passing ozone gas collected from said chamber through pure water,
and by producing ozone water for cleaning said chamber by said ozone water producing apparatus.

9. A substrate processing apparatus according to claim 8, characterized by comprising an ozonolysis apparatus to decompose ozone gas collected from said chamber or said ozone water producing apparatus.

10. A substrate processing apparatus according to claim 8, characterized in that said chamber comprises:
a chamber supply channel to supply a processing fluid including ozone gas, and ozone water; and
a chamber discharge channel to discharge fluids,
and characterized by comprising a mist trap connected to said chamber discharge channel to separate fluids collected from said chamber into liquid and gas,
and characterized by further comprising a recycling ozone gas supply channel between said ozone water producing apparatus and said mist trap to direct ozone gas separated by said mist trap to said ozone water producing apparatus.

11. A substrate processing apparatus according to claim 9, characterized in that said chamber comprises:
a chamber supply channel to supply a processing fluid including ozone gas, and ozone water; and
a chamber discharge channel to discharge fluids,
and characterized by comprising a mist trap connected to said chamber discharge channel to separate fluids collected from said chamber into liquid and gas,
and characterized by further comprising a fluid channel to direct ozone gas separated by said mist trap to said ozone water producing apparatus and said ozonolysis apparatus, said fluid channel for directing said ozone gas to said ozone water producing apparatus comprising a flow rate control valve.

12. A substrate processing apparatus according to claim 8, characterized in that said chamber comprises:
a chamber supply channel to supply a processing fluid including ozone gas, and ozone water; and
a chamber discharge channel to discharge fluids,
and characterized by comprising a mist trap connected to said chamber discharge channel to separate fluids collected from said chamber into liquid and gas,
and characterized by further comprising a recycling ozone gas supply channel between said ozone water producing apparatus and said mist trap to direct ozone gas separated by said mist trap to said ozone water producing apparatus, the downstream end of said recycling ozone gas supply channel being immersed in pure water or ozone water retained in said ozone water producing apparatus.

13. A substrate processing apparatus according to claim 8, characterized in that said ozone water producing apparatus comprises:
an ozone gas exhaust pipe to discharge ozone gas from the upper part of said ozone water producing apparatus;
an ozone water producing apparatus drain pipe to drain ozone water or pure water from the lower part of said ozone water producing apparatus; and
an ozone water supply channel to supply produced ozone water into said chamber.

14. A substrate processing apparatus according to claim 8, characterized by comprising:
an ozone gas generator; and
a pipe to direct ozone gas produced by said ozone gas generator to said ozone water producing apparatus,
the downstream end of said ozone gas pipe being immersed in ozone water or pure water retained in said ozone water producing apparatus.

15. A substrate processing method for processing a substrate by supplying a processing fluid including ozone gas to the substrate, said method being characterized by comprising:
placing said substrate into said chamber;
processing said substrate by supplying said processing fluid to said substrate;
unloading said substrate from said chamber; and then
cleaning said chamber by supplying ozone water into said chamber.

16. A substrate processing method according to claim 15, characterized by producing ozone water for cleaning said chamber by passing ozone gas collected from said chamber through pure water.

17. A substrate processing method according to claim 15, characterized by performing chamber drying by supplying a dry gas to said chamber after cleaning of said chamber.

18. A substrate processing method according to claim 15, characterized by performing chamber drying by raising the temperature inside said chamber after cleaning of said chamber.

19. A substrate processing method for processing a substrate by supplying a processing fluid including ozone gas to the substrate, said method being characterized by comprising:
placing said substrate into said chamber;
processing said substrate by supplying said processing fluid to said substrate;
unloading said substrate from said chamber; and then
producing ozone water by supplying a mixed fluid of ozone gas and steam to said chamber to be condensed in said chamber, or by mixing ozone gas and steam or pure water before flowing into the chamber, in order to clean said chamber.

20. A substrate processing method according to claim 19, characterized by hastening condensation of said ozone gas and steam or production of ozone water by controlling the temperature.
